(19) United States
(12) Patent Application Publication
(10) Pub. No.: US 2011/0025071 A1
(43) Pub. Date: Feb. 3, 2011

(54) HYBRID TYPE VERTICAL SHAFT TURBINE FOR WIND POWER GENERATING DEVICES

(75) Inventors: Enzo CORTESI, Forli (FO) (IT); Saverio SCOZZOLI, Forli (FO) (IT); Paride AGATENSI, Forli (FO) (IT); Massimiliano CASTELLUZZO, Forli (FO) (IT)

Correspondence Address: YOUNG & THOMPSON, 209 Madison Street, Suite 500, Alexandria, VA, 22314, US

(73) Assignee: WINDESIGN S.R.L., Forli (FO) (IT)

(21) Appl. No.: 12/844,995

(22) Filed: Jul. 28, 2010

(30) Foreign Application Priority Data
Jul. 28, 2009 (IT) CO2009A 000026

(51) Int. Cl. F03D 3/06; F04D 29/00; F03D 9/00

(52) U.S. Cl. 290/55; 415/4.2; 416/175

(57) ABSTRACT

A hybrid type vertical shaft turbine (1) for wind power generating devices, includes a supporting structure (2) supporting, concentrically and axially spaced, an internal rotor (3) made of Savonius blades (4) and an external rotor (5) made of Darrieus blades (6), wherein the shaft (7) has the bottom end (12) which may be connected to an electric generator for transforming wind energy into electric energy, wherein both the internal Savonius rotor (3) and the external Darrieus rotor (5) have twisted blades with identical or different values in the axial direction of the turbine. The Savonius blades extend between end flanges (8, 9) to radial arms (10, 11) equispaced in each flange (8, 9) and offset between the flanges (8, 9) to accommodate the external Darrieus blades. The proposed twistings allow considerably improving the continuity of the driving torque generated with the wind velocity increasing towards medium-low, medium and medium-high velocities and vice versa.

### TECHNICAL FIELD OF THE INVENTION

The present invention refers to a hybrid type vertical shaft turbine for wind power generating devices according the preamble of claim 1.

### PRIOR ART

Hybrid turbines of the aforementioned type are known and aim at—by means of an internal assembly of Savonius blades—making the rotor of the hybrid turbine self-starting type in the presence of low wind speeds, also comprising an assembly of external Darrieus blades to exploit higher wind speeds.

Document JP 2007040276 (A) discloses a vertical axis hybrid turbine having an external assembly of Darrieus blades formed by a strip having constant width and decreasing thickness from a central enlargement towards the sides, the Darrieus blades developing in a radial plane and being fixed at the ends to arms in turn fixed to the vertical shaft and having a radius substantially corresponding to the radius of the circumference enclosing the internal assembly made of Savonius blades. The latter are fixed to the shaft and have a constant profile in the constant development thereof.

Also document JP 2009047031 (A) discloses a hybrid turbine having three strip-shaped external Darrieus blades fixed to the vertical shaft and extended in a respective radial plane, having a markedly rounded section, as well as an assembly of four internal Savonius blades having a grooved section and uniform axial development, which are fixed as overlapped pairs to the turbine shaft and terminate spaced from the ends of the shaft, wherein—at the bottom part of the external rotor made of Darrieus blades—an electric generator incorporating a motor unit comprising a rotor-stator for rotating the hybrid turbine in the presence of insufficient minimum wind speed is associated to the shaft.

The use of a generator/motor start unit, and a respective more complex electronic control unit, implies an additional construction burden. Document TW 288796 (B) discloses a hybrid type vertical axis turbine analogous to that disclosed by document JP 2009047031 (A), wherein a ratio ranging from 2.83 up to 5.25 is provided for between the spokes of the Darrieus blades and the Savonius blades with the aim of facilitating the starting of the hybrid turbine at low wind speeds and the general efficiency at high wind speeds. Even in this document the Darrieus blades have a substantially semicircular development and they develop in a radial plane, wherein the ends of the Darrieus blades are practically joined at the ends of the shaft.

The hybrid turbines of the prior art are generally optimised for high wind speeds, they reveal poor performance at low wind speeds and, in presence of low wind speeds they are not always capable of guaranteeing self-starting.

Generally, the wind power generating devices of the prior art are made—from an aerodynamic point of view—for producing the maximum amount of energy at a wind speed ranging between about 9 and 15 m/s.

However, they reveal poor performance in areas normally having medium-low wind intensity. On the other hand, such areas are very common and numerous, for example in Italy.

It would thus be advantageous to provide wind power generating devices for producing renewable electric energy by transforming wind energy into high efficiency electric energy even for areas with low wind speeds.

### SUMMARY OF THE INVENTION

Therefore, the present invention has the main object of developing a vertical axis hybrid turbine simultaneously using external Darrieus blades and internal Savonius blades, which, though rigidly joined to each other, are conceived and made in such a manner that each one of them synergically contributes to the task thereof in the most efficient manner possible, and having a high transfer of the aerodynamic force to the torque on the axis, at different speed ranges at which the hybrid turbine is required to operate, and capable of ensuring self-starting even in presence of low wind speeds.

The aforementioned task is met, according to the invention, by providing a hybrid type vertical shaft turbine for wind power generating devices having the characteristics of claim 1.

Further developments of the proposed hybrid turbine form an object of the dependent claims.

In order to prevent the prior art Darrieus and Savonius technologies from negatively interfering with each other at different rotation speeds, regarding the Darrieus blades a particular aerodynamic profile is proposed and, at the same time, the shape distances and the positioning between the aerodynamic surfaces of the Darrieus blades with respect to the resistant Savonius blades are calculated with particular accuracy.

The hybrid turbine according to the invention allows obtaining various important advantages.

First and foremost the new concept of aerodynamically producing the Darrieus turbine and the Savonius turbine allows obtaining high efficiency in terms of transforming wind energy into electric energy in the presence of different wind speeds, starting from low speeds in the order of 2-3 m/s, through medium-low, medium and high speeds, and vice versa, in that—on one hand—the proposed profile of the Savonius blades allows self-starting at low wind speeds and, as the wind speed increases, it allows a corresponding gradual and continuous increase of speed provided by the shaped blades of the Darrieus turbine offering least resistance possible. Therefore, the proposed hybrid turbines are capable of providing the best energy transformation performance at different wind speeds and according to the variations thereof.

In practice the hybrid turbines according to the invention allow obtaining a high power density (Watt/m²), i.e. the power extractable from the wind per area unit swept by the rotor. Considering, for example, a normal condition, with constant typical air density and having a 10 m/s wind speed, it is possible to obtain a power density of about 220 W/m² with respect to the value of the prior art amounting to only 110-160 W/m².

Furthermore, with respect to said known CP (Coefficient of Performance) of about 0.19 of the Savonius turbine and about 0.25 of the Derrieus turbine, the hybrid turbines according to the invention advantageously allow obtaining an overall coefficient of performance of about 0.37.

The single components of the hybrid turbine may be obtained by means of known technologies and they may be assembled in a quick and simple manner. While the Savonius blades may for example be advantageously made of a metal sheet, the Darrieus blades may be provided for example advantageously made of composite synthetic material, i.e. reinforced with fibres.

The reel-like supporting structure may advantageously be made, optionally, of several parts or modular components easily assembled together.

The substantially helical or twisted configuration of the Darrieus blades may have a different twisting depending on the offset provided for between the radial arms of the end flanges of the reel structure. Provided for as the transverse section of the Darrieus blades is a symmetric or asymmetric wing-shaped section, wherein the fixing between the ends of the Darrieus blades and the associated support arms may advantageously occur by means of geometric engagement/coupling.

### BRIEF DESCRIPTION OF THE DRAWINGS

Further characteristics, advantages and details of the hybrid type vertical shaft turbine for wind power generating devices according to the invention are further observable from the description that follows with reference to the attached drawings, to which reference shall be made for any details not illustrated in-depth in the description and which schematically illustrate by way of an example a hybrid turbine according to the invention.

In the drawings:

FIG. 1 is a perspective view of a hybrid turbine according to the invention,

FIG. 2 is a front elevational view of the turbine of FIG. 1,

FIG. 3 is a top view of the turbine of FIG. 1,

FIG. 4 is a sectional view from the plane of section IV-IV of FIG. 2,

FIG. 5 is a bottom view of a twisted Savonius blade, at an end of the blade settling against an arm of a flange of the reel-like supporting structure, and

FIG. 6 is a transverse section through a wing profile useable for the Darrieus blades.

### DESCRIPTION OF THE PREFERRED EMBODIMENT

In the various figures, provided at different scales for further clarity, identical parts have identical reference numbers.

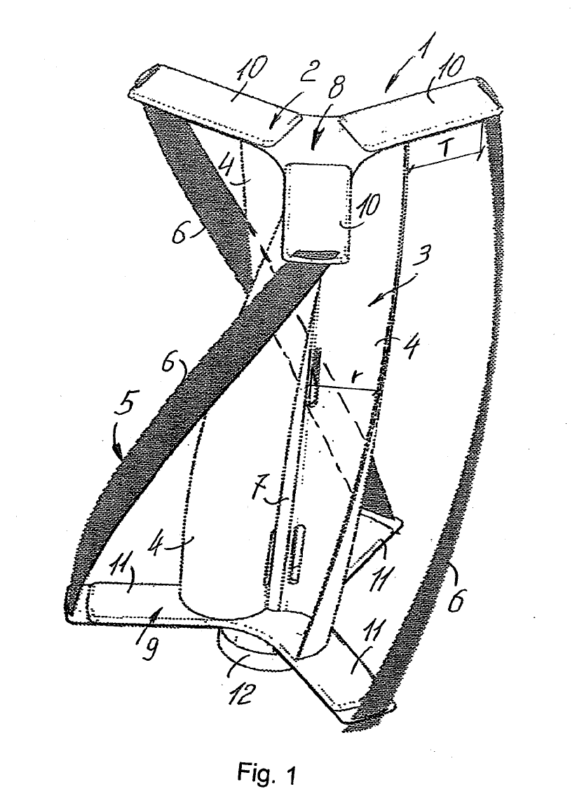

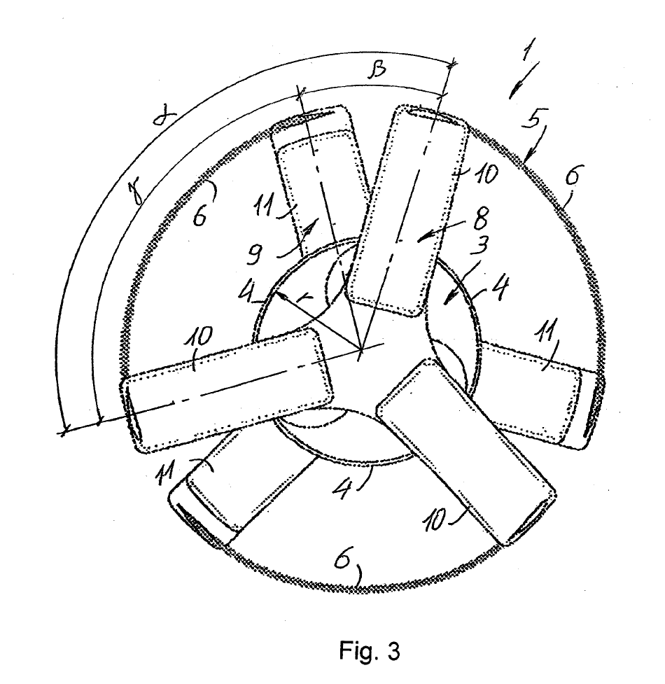

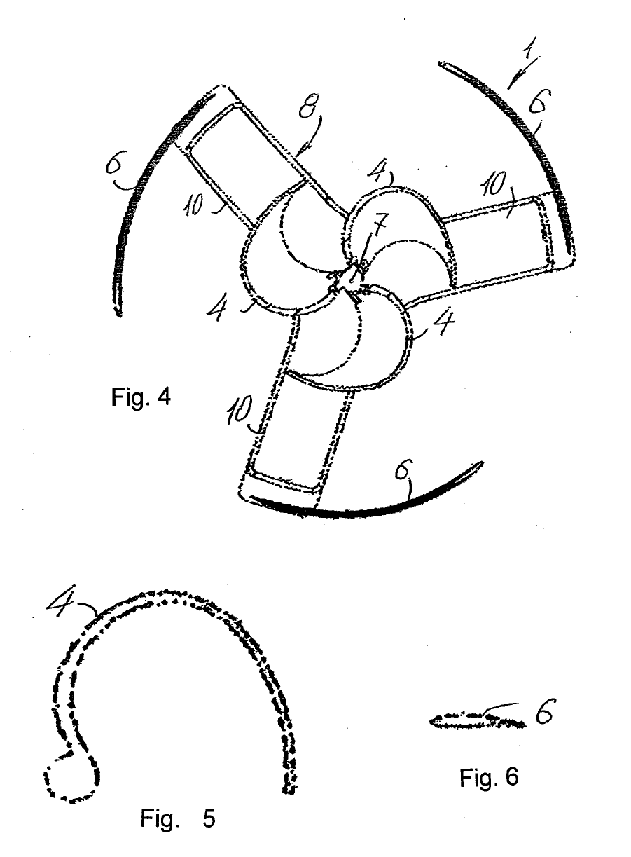

First, reference is made to FIG. 1, wherein the hybrid type vertical shaft turbine for wind power generating devices is indicated in its entirety with 1. It is substantially made up of a supporting structure 2, which concentrically supports an assembly 3 made of internal Savonius blades 4 and an assembly 5 made of external Darrieus blades 6, wherein in the illustrated example the supporting structure 2 is made reel-like and has a central shaft 7 with two end flanges 8, 9. In the illustrated example, the end flanges 8, 9 each have, in the illustrated example, three radial arms 10, respectively 11, arranged equispaced having a 120° angle α (FIG. 3), wherein the arms of a flange are offset with respect to said arms of the other flange for a 30° angle β, in the illustrated example. Thus, as observable particularly from FIG. 3 of the illustrated example, formed from time to time between an adjacent top arm 10 and an adjacent bottom arm 11 in the anticlockwise direction is a 90° angle γ, which forms the twisting angle of the Darrieus blades 6, the torsion preferably practically being imparted to the blades 6 during production thereof, for example made of synthetic material reinforced with fibres, or made of any other suitable material also depending on the production process provided for.

As observable in particular from FIGS. 3 and 6, each Darrieus blade 6 is made of a symmetric or asymmetric wing section, asymmetric in the illustrated example, strip-like having a constant width. In the illustrated example, each Darrieus blade is fixed at the ends thereof respectively in a top arm 10 and in a bottom arm 11 offset therebetween by a twisting angle γ, such intervention imparting to the external Darrieus blades 6 the twisted development provided for according to the invention.

The Savonius blades 4 are extended between the end flanges 8, 9 and they are configured to form a substantially semicircular transverse section and likewise twisted longitudinally, i.e. in axial direction, according to the invention, wherein said Savonius blades 4 in the illustrated example on the internal side thereof are firmly fixed to the shaft 7 of the supporting structure 2, in any suitable manner, as well known to a man skilled in the art.

The shaft 7 has—at the bottom part—an end, projecting from the bottom flange 9, such end terminating having a flange 12, which in turn may be fixed to the shaft of an electric generator, not illustrated, per se known, for transforming wind energy into electric energy.

According to the invention, the fixing of the Darrieus blades 6 to the arms 10, respectively 11, of the supporting flanges 8, 9 occurs integrally and with the arrangement of the width of the wing sections 6 substantially concentric with respect to the support shaft 7, for example, as illustrated, through a geometric coupling.

In the illustrated example, the assembly 3 made of Savonius blades 4 and the assembly 5 made of Darrieus blades 6 have the same number n of blades, i.e. three blades each.

Furthermore, the invention likewise allows providing for a number n of blades different from three for the internal Savonius blades 4 and/or for the external Darrieus blades 6 depending on the contingent application requirements thereof.

According to the basic teaching of the present invention, and as clearly observable from the drawings, the proposed hybrid type vertical axis turbine 1 may generally have both internal Savonius 3 and external Darrieus 5 rotors provided twisted and more precisely with twisting values between 90° and substantially 0°, which may be selected identical or different for the two types of Savonius 4 and Darrieus 6 blades according to the size of the hybrid turbine 1 considered from time to time depending, among other factors, for example on the wind condition in the area of use. Regarding dimensioning, by way of example,
the twisting angle (γ) of the internal Savonius blades 4 and external Darrieus blades 6 is comprised between 90° and substantially 0°,
the ratio between the height (H) of the turbine (1) and the external diameter (D) of the greater circumference enclosing the external rotor (5) of Darrieus blades (6) is comprised between 0.5 and 2.5, preferably 1.4,
the ratio between the greater circumference enclosing the Darrieus blades 6 of the external rotor 5 and the greater circumference enclosing the Savonius blades 4 of the internal rotor 3 is comprised in the range between 2 and 8, preferably 4.8.

Functionally, the teachings of the invention allow obtaining a hybrid type vertical shaft turbine 1 of new conception for wind power generating devices always capable of providing substantially an ideal driving torque available on the turbine shaft in the presence of different wind speeds impacting the proposed hybrid turbine as well as an ideal continuity of the torque upon variation of the wind speed from low values towards medium low, medium and medium high values, and vice versa.

The supporting structure 2, and in particular the end flanges 8, 9 may be made in a single piece, or with modular arms 10, 11 of different radial dimensions and fixable to a central core of the flange, such solution facilitating the production of modular hybrid turbines of various dimensions.

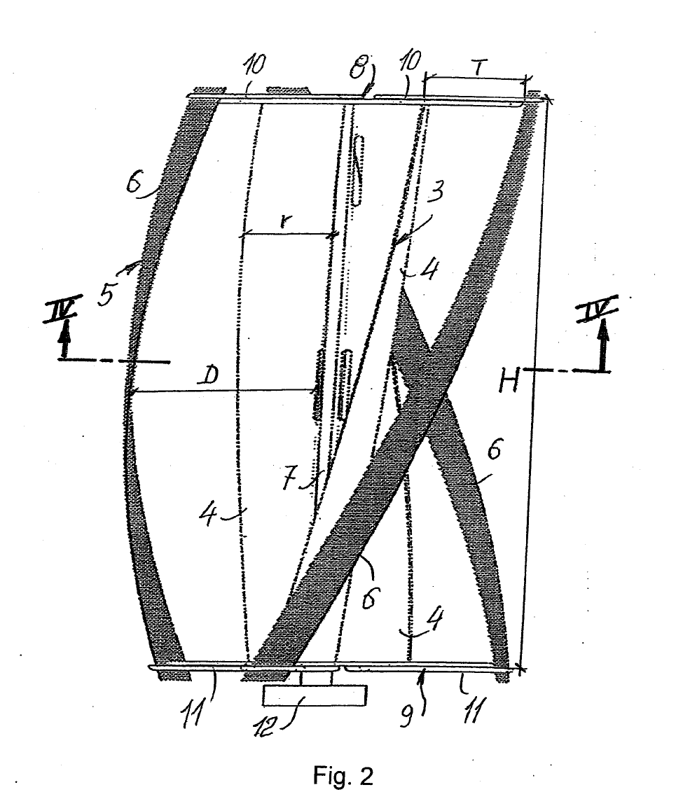

As clearly observable from the drawings, in the hybrid turbine 1 according to the invention, the Darrieus blades 6 do not develop in a radial plane but substantially helical-shaped in the circumferential direction and the ends thereof are fixed to the arms 10 and 11 of the flange 8 and 9 markedly spaced from the resistant Savonius blades 4. Such space T (FIGS. 1 and 2) is, for example, in the order of magnitude of 4-5 times the radius r of the circumferences which encloses the internal Savonius rotor 3. Obviously also this space T may vary depending on the use conditions considered from time to time.

From the structural and functional description above it is observable that the hybrid type vertical shaft turbine according to the invention for wind power generating devices allows efficiently meeting the indicated task and the aforementioned advantages are attained.

According to the invention, the internal blades 4 and/or the external blades 6 may be made both in a single piece, as illustrated, or as several segments to be fixed to the supporting structure 2.

In practice, those skilled in the art may introduce modifications and variants regarding, for example, establishing a different number n of blades for one or both Savonius 3 and Darrieus 5 rotors and, as a consequence, the number and/or configurations of the arms of the supporting flanges, or provide for members for stiffening the Darrieus blades 6, for example arranged at mid-height between the blade and the shaft 7, or provide for—regarding the Darrieus blades 6—symmetric or asymmetric wing sections different from the one illustrated and the ribbed cables, or using Darrieus blades made of light alloy, or provide Darrieus blades extended in a radial plane and twisted along said plane instead of towards the circumferential direction, and so on and so forth, without departing from the scope of protection of the present invention, as illustrated and claimed.

1. Hybrid type vertical shaft turbine for wind power generating devices, comprising a supporting structure which concentrically supports an assembly of internal Savonius blades and an assembly of external Darrieus blades, wherein the turbine shaft has the bottom end which may be connected with an electric generator for transforming wind energy into electric energy, characterised in that said Darrieus type blades (6) of the external rotor (5) and the Savonius type blades (4) of the internal rotor (3) have—one or the other or both—a development which is twisted in the axial direction of the hybrid turbine (1), wherein the value of the twisting is between about 90° and substantially 0°.

2. Hybrid turbine according to claim 1, characterised in that:
a) said supporting structure (2) is realised like a reel having a central shaft (7) and end flanges (8, 9), wherein
each end flange (8; 9) has a plurality of n equispaced radial arms (10; 11),
wherein, seen in the top view, the radial arms (10) of the top flange (8) are angularly offset with respect to said radial arms (11) of the bottom flange (9) with an angle (δ) which determines the twisting of said external Darrieus blades (6), in case of a twisting different from 0°,
b) each internal Savonius type blade (4) extends between said end flanges (8, 9),
it is shaped like a substantially semicircular channel shell, and
it is fixed either on its internal side to said shaft (7) of said supporting structure (2) or to said end flanges (8, 9),
c) each external Darrieus type blade (6) is a symmetrical or asymmetrical wing-type section having a constant width, and
it is fixed at the ends thereof to two offset arms (10, 11) respectively, i.e. to an arm (10) of said top flange (8) and to an arm (11) of said bottom flange (9), wherein the amount of said offset angle (γ) determines the twisting of the respective blade (6).

3. Hybrid turbine according to claim 2, characterised in that by means of said arms (10, 11) of said flange (8, 9) the ends of said internal Savonius blades (4) and said external Darrieus blades (6) are supported spaced from each other, wherein said space between the respectively opposite ends of said internal blades (4) and of said external blades (6) is in the order of magnitude of 4-5 times the radius (r) of the circumference enclosing said internal Savonius rotor (3).

4. Hybrid turbine according to claim 1, characterised in that the fixing of said Darrieus blades (6) to said arms (10, 11) of said supporting flanges (8, 9) preferably occurs through geometric coupling, preferably with a concentric arrangement of the blade section (6) with respect to said shaft (7).

5. Hybrid turbine according to claim 1, characterised in that the internal rotor (3) made of Savonius blades (4) and the external rotor (5) made of Darrieus blades (6) have an identical or different number (n) of blades.

6. Hybrid turbine according to claim 1, characterised in that the twisting angle (γ) is in the range between about 90° and substantially 0°, for example having an angle of said internal Savonius blades (4) of 45°-90° and having an angle of said external Darrieus blades (6) between substantially 0° and 45°.

7. Hybrid turbine according to claim 1, characterised in that the ratio between the height (H) of the turbine (1) and the external diameter (D) of the greater circumference enclosing the external rotor (5) made of Darrieus blades (6) is in the range between 0.5 and 2.5, preferably 1.4.

8. Hybrid turbine according to claim 1, characterised in that the ratio between the greater circumference enclosing the Darrieus blades (6) of the external rotor (5) and the greater circumference enclosing the Savonius blades (4) of the internal rotor (3) is comprised in the range between 2 and 8 and preferably about 4.8.

9. Hybrid turbine according to claim 1, characterised in that said internal Savonius blades (4) have a channel-like transverse section.

10. Hybrid turbine according to claim 1 characterised in that said internal blades (4) and/or said external blades (6) are made in a single piece or in several portions, which are joined to the supporting structure (2).

11. Hybrid turbine according to claim 1 characterised in that the arms (10, 11) of said flanges (8, 9) are made as single piece with the respective flanges (8, 9) or they are made separate, with modular dimensions and joined removeably with said flange (8, 9).

12. Wind power generating device for transforming wind energy into electric energy characterised in that it comprises a hybrid type vertical shaft turbine (1) according to claim 1.
